(19) United States
(12) Patent Application Publication
(10) Pub. No.: US 2025/0159492 A1
(43) Pub. Date: May 15, 2025

(54) MEASUREMENT CONTROL METHOD, TERMINAL, AND NETWORK SIDE DEVICE

(71) Applicant: VIVO MOBILE COMMUNICATION CO., LTD., Dongguan (CN)

(72) Inventors: Ranran HE, Dongguan (CN); Yanxia ZHANG, Dongguan (CN); Xiao XIAO, Dongguan (CN)

(73) Assignee: VIVO MOBILE COMMUNICATION CO., LTD., Dongguan (CN)

(21) Appl. No.: 19/021,017

(22) Filed: Jan. 14, 2025

Related U.S. Application Data
(63) Continuation of application No. PCT/CN2023/106704, filed on Jul. 11, 2023.

(30) Foreign Application Priority Data
Jul. 15, 2022 (CN) 202210833836.4

(51) Int. Cl. H04W 16/18; H04B 17/318; H04W 24/10; H04W 84/06

(52) U.S. Cl. CPC H04W 16/18; H04B 17/318; H04W 24/10; H04W 84/06

(57) ABSTRACT

This application discloses a measurement control method, a terminal, and a network side device. The measurement control method includes: when a terminal does not enter a first region or is getting away from the first region, skipping performing, by the terminal, measurement on a neighboring cell at a first frequency, where the first region is within a coverage range of a network of a first network type, the first frequency is at least one of a second frequency associated with the first region, and the second frequency is a frequency used for deployment of the network of the first network type.

### CROSS-REFERENCE TO RELATED APPLICATIONS

This application is a continuation of International Application No. PCT/CN2023/106704, filed Jul. 11, 2023, which claims priority to Chinese Patent Application No. 202210833836.4, filed Jul. 15, 2022. The entire contents of each of the above-referenced applications are expressly incorporated herein by reference.

### TECHNICAL FIELD

This application relates to the field of wireless communication technologies, and specifically, to a measurement control method, a terminal, and a network side device.

### BACKGROUND

A Non-Terrestrial Network (NTN) is a network or a network segment that performs transmission by using a satellite, an Unmanned Aircraft System (UAS) platform, or a High-Altitude Platform System (HAPS), and compared with a terrestrial communication system, a satellite-based non-terrestrial communication system has a wider coverage range. Typical scenarios to which the NTN is applied include cases that a terrestrial base station cannot be built and a terrestrial base station is damaged, for example, continuous coverage in remote mountainous regions, deserts, oceans, or forests, or emergency communication when natural disasters occur or a terrestrial base station is damaged.

A coverage range of an NTN cell is much greater than a coverage range of a Terrestrial Network (TN) cell, and as shown in FIG. 1, the coverage of one NTN cell may overlap with coverage of a plurality of TN cells. In the related art, if a terminal starts measurement on a TN frequency (different from an NTN frequency), the terminal must perform the measurement. However, for a terminal not located in a coverage range of a TN cell, even the measurement on the TN frequency is performed, the terminal does not reselect the TN cell, leading to unnecessary power consumption of the terminal.

### SUMMARY

Embodiments of this application provide a measurement control method, a terminal, and a network side device, which can reduce unnecessary measurement on a neighboring cell and reduce power consumption of a terminal.

According to a first aspect, a measurement control method is provided, including: in a case that a terminal does not enter a first region or is getting away from the first region, skipping performing, by the terminal, measurement on a neighboring cell at a first frequency or performing relaxation measurement on the neighboring cell at the first frequency, where the first region is within a coverage range of a network of a first network type, the first frequency is at least one of a second frequency associated with the first region, and the second frequency is a frequency used for deployment of the network of the first network type.

According to a second aspect, a measurement control apparatus is provided, including: an evaluation module, configured to evaluate whether a terminal does not enter a first region or is getting away from the first region; and a control module, configured to control the terminal to skip performing measurement on a neighboring cell at a first frequency or perform relaxation measurement on the neighboring cell at the first frequency in a case that the terminal does not enter the first region or is getting away from the first region, where the first region is within a coverage range of a network of a first network type, the first frequency is at least one of a second frequency associated with the first region, and the second frequency is a frequency used for deployment of the network of the first network type.

According to a third aspect, a measurement control policy configuration method is provided, including: configuring, by a network side device, a measurement control policy for a terminal, where the measurement control policy indicates the terminal to skip performing measurement on a neighboring cell at a first frequency or perform relaxation measurement on the neighboring cell at the first frequency in a case that the terminal does not enter a first region or is getting away from the first region.

According to a fourth aspect, a measurement control policy configuration apparatus is provided, including: an obtaining module, configured to obtain a measurement control policy of a terminal, where the measurement control policy indicates the terminal to skip performing measurement on a neighboring cell at a first frequency or perform relaxation measurement on the neighboring cell at the first frequency in a case that the terminal does not enter a first region or is getting away from the first region; and a configuration module, configured to configure the measurement control policy for the terminal.

According to a fifth aspect, a terminal is provided, including a processor and a memory, where the memory stores a program or an instruction executable on the processor, and when the program or the instruction is executed by the processor, the steps of the method according to the first aspect are implemented.

According to a sixth aspect, a terminal is provided, including a processor and a communication interface, where the processor is configured to implement the steps of the method according to the first aspect, and the communication interface is configured to communicate with an external device.

According to a seventh aspect, a network side device is provided, including a processor and a memory, where the memory stores a program or an instruction executable on the processor, and when the program or the instruction is executed by the processor, the steps of the method according to the third aspect are implemented.

According to an eighth aspect, a network side device is provided, including a processor and a communication interface, where the processor is configured to implement the steps of the method according to the third aspect, and the communication interface is configured to communicate with an external device.

According to a ninth aspect, a measurement control system is provided, including: a terminal and a network side device, where the terminal may be configured to implement the steps of the method according to the first aspect, and the network side device may be configured to implement the steps of the method according to the third aspect.

According to a tenth aspect, a readable storage medium is provided, having a program or an instruction stored therein, where when the program or the instruction is executed by a processor, the steps of the method according to the first aspect are implemented, or the steps of the method according to the third aspect are implemented.

According to an eleventh aspect, a chip is provided, including a processor and a communication interface, where the communication interface is coupled to the processor, and the processor is configured to execute a program or an instruction, to implement the steps of the method according to the first aspect, or implement the steps of the method according to the third aspect.

According to a twelfth aspect, a computer program/program product is provided, where the computer program/program product is stored in a storage medium, and the computer program/program product is executed by at least one processor to implement the steps of the method according to the first aspect, or implement the steps of the method according to the third aspect.

In the embodiments of this application, in a case that the terminal does not enter the first region within the coverage range of the network of the first network type or is getting away from the first region, the terminal skips performing measurement on at least one frequency associated with the first region or performs relaxation measurement on the at least one frequency associated with the first region, so that a problem of an increase in power consumption of the terminal caused by execution of unnecessary measurement or measurement with an excessively high standard on the at least one frequency associated with the first region in a case that the terminal does not enter the first region or is getting away from the first region can be avoided, thereby reducing unnecessary measurement on a neighboring cell and achieving an objective of saving power.

### BRIEF DESCRIPTION OF THE DRAWINGS

FIG. 1 is a diagram of an example of coverage ranges of an NTN cell and a TN cell;

FIG. 2 is a block diagram of a wireless communication system to which an embodiment of this application is applicable;

FIG. 3 is a schematic flowchart of a measurement control method according to an embodiment of this application;

FIG. 4 is a schematic diagram of network deployment to which an embodiment of this application is applicable;

FIG. 5 is a schematic flowchart of a measurement control policy configuration method according to an embodiment of this application;

FIG. 6 is a schematic structural diagram of a measurement control apparatus according to an embodiment of this application;

FIG. 7 is a schematic structural diagram of a measurement control policy configuration apparatus according to an embodiment of this application;

FIG. 8 is a schematic structural diagram of a communication device according to an embodiment of this application;

FIG. 9 is a schematic structural diagram of hardware of a terminal according to an embodiment of this application; and

FIG. 10 is a schematic structural diagram of hardware of a network side device according to an embodiment of this application.

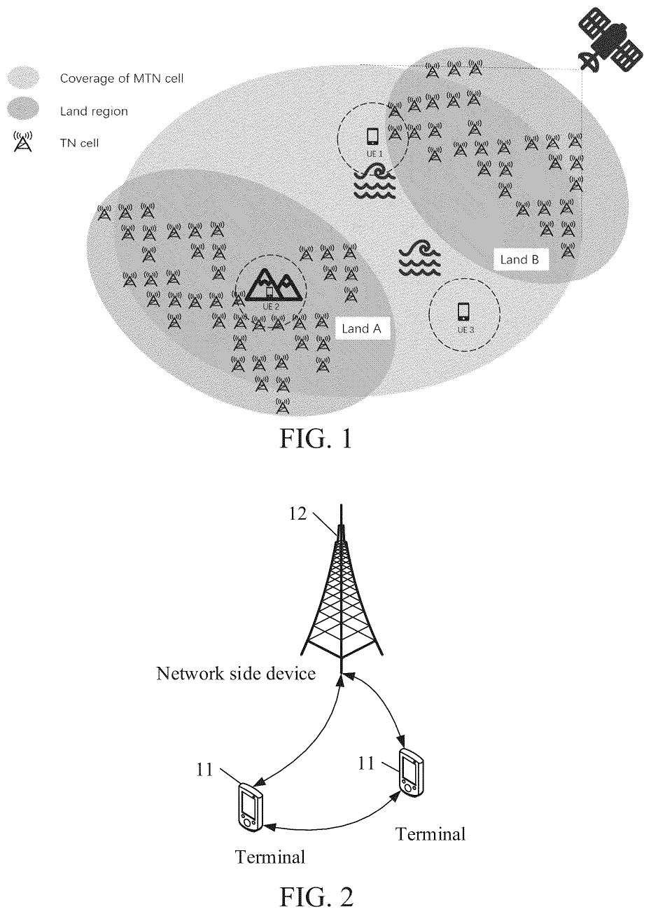

### DETAILED DESCRIPTION

The technical solutions in embodiments of this application are clearly described below with reference to the accompanying drawings in the embodiments of this application. Apparently, the described embodiments are merely some rather than all of the embodiments of this application. All other embodiments obtained by a person of ordinary skill in the art based on the embodiments of this application fall within the protection scope of this application.

In the specification and the claims of this application, the terms “first” and “second” are used to distinguish similar objects, but are not used to describe a specific sequence or order. It should be understood that the terms used in this way are interchangeable in proper circumstances, so that the embodiments of this application can be implemented in another sequence other than those illustrated or described herein. In addition, the objects distinguished by “first” and “second” generally belong to the same category and a number of the objects is not limited. For example, there may be one or more first objects. In addition, in the specification and the claims, “and/or” indicates at least one of connected objects, and the character “/” generally indicates an “or” relationship between associated objects.

It should be noted that technologies described in the embodiments of this application are not limited to a Long Term Evolution (LTE)/LTE-Advanced (LTE-A) system, and may further be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. Terms “system” and “network” in the embodiments of this application may usually be used interchangeably. The described technology may be applied to the foregoing mentioned systems and radio technologies, and may also be applied to other systems and radio technologies. The following describes a New Radio (NR) system for an exemplary purpose, and NR terms are used in most of the description below. These technologies may also be applied to an application other than an NR system application, such as a 6th Generation (6G) communication system.

FIG. 2 is a block diagram of a wireless communication system to which an embodiment of this application is applicable. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (home devices with a wireless communication function, such as a refrigerator, a television, a washing machine, a furniture, or the like), a game console, a personal computer (PC), a teller machine, or a self-service machine. The wearable device includes a smart watch, a smart band, a smart headset, smart glasses, a smart jewelry (a smart bangle, a smart bracelet, a smart ring, a smart necklace, a smart anklet, or a smart anklet bracelet), a smart wristlet, a smart clothes, or the like. It should be noted that, a specific type of the terminal 11 is not limited in the embodiments of this application. The network side device 12 may include an access network device or a core network device, where the access network device 12 may also be referred to as a radio access network device, a Radio Access Network (RAN), a radio access network function, a radio access network unit, or the like. The access network device 12 may include a base station, a WLAN access point, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field, and provided that the same technical effect can be achieved, the base station is not limited to a specific technical term. It should be noted that, a base station in an NR system is only used as an example in the embodiments of this application, and a specific type of the base station is not limited.

The following describes in detail the measurement control solutions provided in the embodiments of this application with reference to the accompanying drawings and through some embodiments and application scenarios thereof.

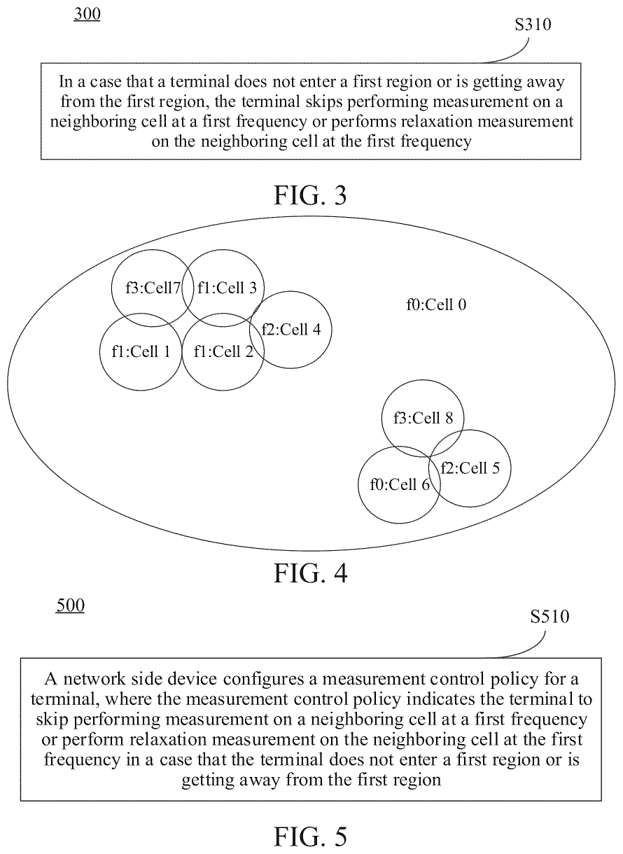

FIG. 3 is a schematic flowchart of a measurement control method according to an embodiment of this application. The method 300 may be performed by a terminal. In other words, the method may be performed by software or hardware installed on the terminal. As shown in FIG. 3, the method may include the following steps.

S310. In a case that the terminal does not enter a first region or is getting away from the first region, the terminal skips performing measurement on a neighboring cell at a first frequency or performs relaxation measurement on the neighboring cell at the first frequency.

In the embodiments of this application, the first region is within a coverage range of a network of a first network type, the first frequency is at least one of a second frequency associated with the first region, and the second frequency is a frequency used for deployment of the network of the first network type.

That is, in the embodiments of this application, the first region is a region within the coverage range of the network of the first network type, and in a case that the first region is likely to be associated with at least one frequency used for deployment of the network of the first network type and the terminal does not enter or is getting away from the first region, the terminal skips performing measurement on a neighboring cell at the at least one frequency or performs relaxation measurement on the neighboring cell at the at least one frequency. For example, there are one or more first frequencies; and the first region is a region within the network of the first network type (for example, a TN).

In the embodiments of this application, relaxation measurement has a measurement requirement different from that of normal measurement.

In an implementation, the first frequency may include at least one of the following:
(1) a dedicated frequency used for deployment of the network of the first network type; or
(2) a shared frequency used for deployment of the network of the first network type and a network of a second network type, where the second network type is different from the first network type.

The first network type may be any one of a TN network or an NTN network, and the first network type is different from the second network type.

In some embodiments, that the terminal skips performing measurement on a neighboring cell at a first frequency or performs relaxation measurement on the neighboring cell at the first frequency includes at least one of the following:
(1) In a case that the first frequency includes the dedicated frequency used for deployment of the network of the first network type and the terminal does not enter the first region or is getting away from the first region, the terminal skips performing measurement on the neighboring cell at the first frequency. For the dedicated frequency used for deployment of the network of the first network type, the terminal may not reselect a cell at the dedicated frequency, so that the terminal may skip performing measurement on the neighboring cell at the first frequency.
(2) In a case that the first frequency includes the shared frequency used for deployment of the network of the first network type and the network of the second network type and the terminal does not enter the first region or is getting away from the first region, the terminal performs relaxation measurement on the neighboring cell at the first frequency. For the shared frequency used for deployment of the network of the first network type (for example, a TN network) and the network of the second network type (for example, an NTN network), the terminal may not reselect a cell at the shared frequency, so that power of the terminal can be reduced by relaxing measurement on the shared frequency.

For example, in a case that the terminal does not enter or is getting away from the first region, the terminal may exclude/relax measurement on neighboring cells at some frequencies, for example, may exclude measurement on some dedicated (for example, TN-only) frequencies of the network of the first network type, or relax measurement on some TN-NTN shared frequencies. In some embodiments, the following two scenarios may be included: 1) The terminal resides in an NTN cell, and the neighboring cell includes a TN cell; and 2) the terminal resides in a TN cell, and the neighboring cell includes an NTN cell.

Furthermore, if the terminal starts measurement on the neighboring cell at the first frequency according to a cell reselection measurement criterion, but the terminal has not entered/is getting away from the first region, the terminal also skips performing measurement on the neighboring cell at the first frequency or performs relaxation measurement on the neighboring cell at the first frequency; and on the contrary, if the terminal enters/is getting close to the first region, the terminal performs measurement on the neighboring cell at the first frequency.

The first frequency includes at least one of the following:
(1) an intra-frequency, that is, a frequency that is the same as a current frequency;
(2) an inter-frequency or an inter-system frequency (inter-RAT frequency) having a higher reselection priority than a reselection priority of the current frequency;
(3) an inter-frequency or an inter-system frequency having the same reselection priority as the current frequency; or
(4) an inter-frequency or an inter-system frequency having a lower reselection priority than the reselection priority of the current frequency.

The current frequency is a frequency of a serving cell in which the terminal resides.

In the embodiments of this application, that the terminal skips performing measurement on the neighboring cell at the first frequency includes one of the following: skipping searching the first frequency, skipping measuring the first frequency, or skipping searching and measuring the first frequency.

In the embodiments of this application, the terminal may be in a non-connected state, for example, an idle state or an inactive state.

According to the technical solution provided in the embodiments of this application, in a case that the terminal does not enter the first region within the coverage range of the network of the first network type or is getting away from the first region, the terminal skips performing measurement on at least one frequency associated with the first region or performs relaxation measurement on the at least one frequency associated with the first region, so that a problem of an increase in power consumption of the terminal caused by execution of unnecessary measurement on the at least one frequency associated with the first region in a case that the terminal does not enter the first region or is getting away from the first region can be avoided, thereby reducing unnecessary measurement on a neighboring cell and achieving an objective of saving power.

In an implementation, before S310, the method further includes: the terminal starts measurement on the neighboring cell at the first frequency. That is, in an implementation, after the terminal starts measurement on the neighboring cell at the first frequency, if it is determined that the terminal does not enter the first region or is getting away from the first region, the terminal skips measurement on the neighboring cell at the first frequency or performs relaxation measurement on the neighboring cell at the first frequency instead of normally performing measurement on the neighboring cell at the first frequency after measurement on the neighboring cell at the first frequency is started, so that unnecessary measurement can be reduced, thereby saving electric energy of the terminal.

In an implementation, the first region may include at least one of the following:
(1) A region associated with at least one first cell, where a network type of the first cell is the first network type. That is, the first region may include a coverage region of the at least one first cell. For example, the first region may include coverage regions of a plurality of adjacent cells in a TN network. The at least one first cell may be one or more cells, or may be one or more cell groups.

In some embodiments, the second frequency may be a frequency at which the at least one first cell is located.

For example, the first region is associated with one cell, the terminal may determine a relationship between the terminal and the first region associated with each cell, and if the terminal has not entered/is getting away from the first region associated with the cell, the terminal may exclude/relax measurement on the frequency. For example, in FIG. 4, a serving frequency is f0, inter-frequencies or inter-system frequencies having a higher reselection priority than the reselection priority of the current frequency are f1 and f3, and an inter-frequency or an inter-system frequency having a lower reselection priority than the reselection priority of the current frequency is f2. A Cell 1 is associated with a region 1, a Cell 2 is associated with a region 2, . . . , and a Cell 8 is associated with a region 8, and if the terminal has not entered/is getting away from the regions 1, 2, and 3, the terminal may exclude/relax measurement on a neighboring cell at f1.

Further, if the terminal starts measurement on a neighboring cell at an inter-frequency with a higher priority or an inter-system frequency with a higher priority (that is, the terminal should measure f1 and f3), the terminal further determines a relationship between the terminal and the first region, that is, determines a relationship between the terminal and the regions 1, 2, 3, and 8. If the terminal gets away from the regions 1, 2, and 3 or is not located in the regions 1, 2, and 3, the terminal may save power for measuring f1; and if the terminal approaches/is getting into any one of the regions 1, 2, and 3, the terminal cannot exclude/relax measurement on f1.

In another example, the first region is associated with a cell group, and for example, {Cell 1, Cell 2, Cell 3, Cell 4, Cell 7} is associated with a region 1, and {Cell 5, Cell 6, Cell 8} is associated with a region 2; and if the terminal starts measurement on a neighboring cell at an inter-frequency with a higher priority or an inter-system frequency with a higher priority (that is, the terminal should measure f1 and f3), the terminal further determines a relationship between the terminal and the first region, that is, determines a relationship between the terminal and the region 1 as well as the region 2. If the terminal is getting away from the region 1 and the region 2 or is not located in the region 1 and the region 2, the terminal may skip performing measurement on neighboring cells at f1 and f3 or relax measurement a neighboring cell at f1 and f3, so that power for measuring f1 and f3 may be saved.
(2) A region associated with at least one third frequency, where the third frequency is a frequency used for deployment of the network of the first network type. That is, the first region may include a region covered by the at least one third frequency used for deployment of the network of the first network type.

In some embodiments, the second frequency may be the at least one third frequency.

The first region may be associated with one or more third frequencies, or may be associated with one or more frequency groups, where each frequency group includes one or more third frequencies. For example, in FIG. 4, the first region is associated with one frequency. For example, f0 is associated with a region 0, f1 is associated with a region 1, f2 is associated with a region 2, and f3 is associated with a region 3. If the terminal has not entered/is getting away from the region 0, the terminal may exclude/relax measurement on a neighboring cell at f0; and if the terminal has not entered/is getting away from the region 2, the terminal may exclude/relax measurement on a neighboring cell at f2.

Further, if the terminal starts measurement on a neighboring cell at an inter-frequency with a higher priority or an inter-system frequency with a higher priority (that is, the terminal should measure f1 and f3), the terminal further determines a relationship between the terminal and the first region, that is, determines a relationship between the terminal and regions associated with f1 and f3. If the terminal is getting away from the region associated with f1 or is not located in the region associated with f1, power for measuring f1 can be saved; and if the terminal is getting away from the region associated with f3 or is not located in the region associated with f3, power for measuring f3 can be saved.

In another example, the first region may be associated with one frequency group (the frequency group may be arbitrarily divided). For example, in FIG. 4, f0 is associated with a region 0, f1 and f2 are associated with a region 1, and f3 is associated with a region 2. If the terminal has not entered/is getting away from the region 1, the terminal may exclude/relax measurement on neighboring cells at f1 and f2.

Further, if the terminal starts measurement on a neighboring cell at an inter-frequency with a higher priority or an inter-system frequency with a higher priority (that is, the terminal should measure f1 and f3), the terminal further determines a relationship between the terminal and the first region, that is, determines a relationship between the terminal and the region 1 as well as the region 2. If the terminal is getting away from the region 1 or is not located in the region 1, power for measuring f1 can be saved; and if the terminal is getting away from the region 2 or is not located in the region 2, power for measuring f3 can be saved.

A granularity of the first region may also be each frequency group (division is performed according to inter-frequencies and intra-frequencies having higher, lower, or same priority than a current serving frequency). For example, an intra-frequency corresponds to a region 0, a frequency having a higher priority than the current serving frequency corresponds to a region 1, and an inter-frequency or an inter-system frequency having the same or a lower reselection priority than the reselection priority of the current frequency corresponds to a region 2. If the terminal has not entered/is getting away from the region 1, the terminal may exclude measurement on neighboring cells at all frequencies with a higher priority.

Furthermore, if the terminal starts measurement on a neighboring cell at an inter-frequency with a higher priority or an inter-system frequency with a higher priority (that is, the terminal should measure f1 and f3), the terminal further determines a relationship between the terminal and the first region, that is, determines a relationship between the terminal and the region 1. If the terminal gets away from the region 1 or is not located in the region 1, power for measuring f1 and f3 can be saved.

In an implementation, before S310, the method may further include: the terminal performs a process of obtaining related information of the first region. The related information of the first region may be description information of the first region, and through the related information of the first region, the terminal may determine a range of the first region. For example, the related information of the first region may include a reference position of the first region and a distance threshold, and the terminal may determine that the range of the first region is a range in which a distance between the terminal and the reference position does not exceed the distance threshold.

In the embodiments of this application, the related information of the first region may be preconfigured, for example, pre-stored in the terminal, or may be preconfigured by a network side device for the terminal through Radio Resource Control (RRC) signaling, or may be preconfigured by a network side for the terminal through a Non Access Stratum (NAS) message.

In some embodiments, the related information of the first region may be dynamically configured by the network side, for example, configured by the network side for the terminal through a system message (for example, SIB 3, SIB 4, SIB 19), terminal dedicated signaling (for example, an RRC release message), or the like.

In an implementation, a result of the process of obtaining the related information of the first region performed by the terminal may be that the related information of the first region is not obtained. For example, in a case that the related information of the first region is configured by the network side, if the network side does not configure the related information of the first region for the terminal, the terminal performs the process of obtaining the related information of the first region but does not obtain the related information of the first region. In this case, behaviors of the terminal may include one of the following:
(1) Perform measurement on the neighboring cell at the first frequency. That is, the terminal performs S310 only when the related information of the first region is obtained (also may be referred to as that when the first region exists), and when the related information of the first region is not obtained (also may be referred to as that when the first region does not exist), the terminal performs measurement according to a mechanism in the related art.
(2) Skip performing measurement on the neighboring cell at the first frequency.
(3) Perform relaxation measurement on the neighboring cell at the first frequency.

In the foregoing (2) and (3), the terminal considers a case that the related information of the first region is not obtained (that is, the first region does not exist) as a case that the terminal has not entered/is getting away from the first region.

In the foregoing implementations, if the first region is associated with at least one first cell, for a cell deployed at a frequency, provided that related information of one first cell is not obtained, it is considered that the related information of the first region is not obtained. For example, the network side configures Cells 1, 2, and 3 at the frequency f1, the first region is associated with the cell group (the Cells 1, 2, and 3), but only region related information of the Cells 1 and 2 are configured, the terminal considers that the related information of the first region is not obtained.

In an implementation, before S310, the method may further include: the terminal obtains a measurement control policy agreed on in a protocol or configured by a network, where the measurement control policy indicates to skip performing measurement on the neighboring cell at the first frequency or perform relaxation measurement on the neighboring cell at the first frequency in a case that the terminal does not enter the first region or is getting away from the first region.

That is, in the embodiments of this application, the behavior of “skipping performing measurement on the neighboring cell at the first frequency or performing relaxation measurement on the neighboring cell at the first frequency in a case that the terminal does not enter the first region or is getting away from the first region” may be agreed on in a protocol or configured by a network. If the behavior is agreed on in a protocol, the terminal always performs the behavior. For example, in a case that the network side configures the related information of the first region, the terminal performs the measurement control policy. If the behavior is configured by the network side, the terminal performs the behavior only when the network side configures the terminal to perform the behavior. For example, the network side may use 1-bit indication field to configure the terminal to perform or not perform the behavior. In some embodiments, for example, when the indication field exists and a value of the indication field is true, the terminal performs the behavior; and when the indication field does not exist, the terminal does not perform the behavior. In another example, when the indication field is 1/true, the terminal performs the behavior, when the indication field is 0/false, the terminal does not perform the behavior, and vice versa. The terminal may be a terminal having a related capability. For example, the related capability is a capability of supporting idle/inactive power saving or a capability of supporting in obtaining the related information of the first region.

In an implementation, in a case that the terminal enters the first region or is getting close to the first region, the terminal preferentially selects or preferentially reselects a cell corresponding to the first network type. For example, after the terminal starts measurement on the neighboring cell at the first frequency, if the terminal evaluates that the terminal enters the first region or is getting close to the first region, the terminal may perform measurement on the neighboring cell at the first frequency, and preferentially select or preferentially reselect the cell corresponding to the first network type.

In an implementation, that the terminal preferentially selects or preferentially reselects a cell corresponding to the first network type includes at least one of the following:
(1) The terminal starts measurement on the second frequency. For example, if the first region is associated with one frequency and the terminal enters/is getting close to the first region, the terminal should start measurement on a neighboring cell at the frequency; if the first region is associated with a plurality of frequencies and the terminal enters/is getting close to the first region, the terminal should start measurement on neighboring cells at the plurality of frequencies; if the first region is associated with one cell and the terminal enters/is getting close to the first region, the terminal should start measurement on a frequency at which the cell is located; and if the first region is associated with a plurality of cells and the terminal enters/is getting close to the first region, the terminal should start measurement on a plurality of frequencies at which the plurality of cells are located.
(2) The terminal sets a priority of the second frequency to the highest. That is, the terminal considers the priority of the second frequency as the highest, namely, higher than a priority of another neighboring frequency. By setting the priority of the second frequency to the highest, when cell selection or reselection is performed, a cell corresponding to the second frequency can be preferentially selected.
(3) The terminal increases the priority of the second frequency by a first offset value. For example, if the terminal enters/is getting close to the first region, a priority of a frequency associated with the first region is equal to a sum of a priority configured by the network and the first offset value. By increasing the priority of the first frequency associated with the first region, when cell selection or reselection is performed, a cell corresponding to the first frequency can be preferentially selected. When there are a plurality of second frequencies, all the second frequencies may share the same first offset value; or each second frequency uses a different first offset value. First offset values corresponding to the second frequencies may be the same or different; or a first part of second frequencies share one offset value, a second part of second frequencies share another offset value, and the rest may be deduced by analogy, where the first offset values may be the same or different.
(4) The terminal increases a value of a parameter related to a reselection criterion of a second cell by a second offset value. In some embodiments, the second cell includes the first cell associated with the first region. For example, if the terminal enters/is getting close to the first region, the value of the parameter related to the reselection criterion of the second cell associated with the first region is equal to a sum of a parameter value configured by the network and the second offset value. By increasing the value of the parameter related to the reselection criterion of the second cell associated with the first region, when cell selection or reselection is performed, the second cell can be preferentially selected. When there are a plurality of second cells, all the second cells may share the same second offset value; or each second cell uses a different second offset value. Second offset values corresponding to the second cells may be the same or different; or a first part of second cells share one second offset value, a second part of second cells share another second offset value, and the rest may be deduced by analogy, where the second offset values may be the same or different.

The parameter related to the reselection criterion includes but is not limited to at least one of the following:
a cell selection reception level value Srxlev;
a cell selection quality value Squal; or
a cell R value.
(5) The terminal decreases a threshold related to the reselection criterion of the second cell by a third offset value.

The threshold related to the reselection criterion includes at least one of the following:
an Srxlev threshold ThreshX, HighP used by the terminal when the terminal reselects an inter-frequency or inter-system frequency having a higher priority than a current serving frequency;
an Squal threshold ThreshX, HighQ used by the terminal when the terminal reselects the inter-frequency or inter-system frequency having a higher priority than the current serving frequency;
an Srxlev threshold ThreshX, LowP used by the terminal when the terminal reselects and reselects an inter-frequency or inter-system frequency having a lower priority than the current serving frequency; or
an Squal threshold ThreshX, LowQ used by the terminal when the terminal reselects and reselects the inter-frequency or inter-system frequency having a lower priority than the current serving frequency.

For example, if the frequency associated with the first region is a frequency having a higher priority and the first region is associated with the first cell, when the terminal evaluates the reselection criterion, the terminal applies the second offset value to Squal, Srxlev, ThreshX, HighQ, ThreshX, HighP, or TreselectionRAT for the first cell, so that the reselection criterion can be met more easily.

If the frequency associated with the first region is a frequency having a lower priority and the first region is associated with the first cell, when the terminal evaluates the reselection criterion, the terminal applies the second offset value to Squal, Srxlev, ThreshServing LowQ, ThreshServing LowP, ThreshX, LowQ, ThreshX, LowP, or TreselectionRAT for the first cell, so that the reselection criterion can be met more easily.

If the frequency associated with the first region is a frequency or an intra-frequency having the same priority and the first region is associated with the first cell, when the terminal evaluates the reselection criterion, the terminal applies the second offset value to an R criterion for the first cell, so that a rank of the first cell is increased.
(6) The terminal applies a parameter related to a cell reselection criterion dedicated to the first network type to perform cell reselection. In this way, a cell dedicated to the first network type can be reselected.

In an implementation, in a case that a network type of a serving cell of the terminal is the first network type, that the terminal preferentially selects or preferentially reselects a cell corresponding to the first network type includes at least one of the following:
(1) The terminal considers a priority of a frequency at which the serving cell is located as the highest, that is, higher than a reselection priority of another neighboring frequency. Through this possible implementation, the terminal may preferentially reside in the current serving frequency/serving cell, so that a frequency of cell reselection of the terminal is reduced.
(2) The terminal increases a value of a parameter related to a measurement criterion by a fourth offset value. The parameter related to the measurement criterion includes at least one of the following:
a cell selection reception level value Srxlev; or
a cell selection quality value Squal.

For example, the terminal applies the fourth offset value to Srxlev or Squal, so that a measurement start condition can be met more difficultly, thereby avoiding frequent switching of the terminal.
(3) The terminal applies a parameter related to a measurement criterion dedicated to the first network type. For example, the network side may configure a threshold related to the measurement criterion of the first network type to a lower value or configure an offset value related to the measurement criterion of the first network type to a lower value, so that the terminal is less likely to start measurement on a neighboring cell.
(4) The terminal decreases a threshold related to the measurement criterion by a fifth offset value.

The threshold related to the measurement criterion includes at least one of the following:
an intra-frequency measurement Srxlev threshold SIntraSearchP;
an intra-frequency measurement Squal threshold SIntraSearchQ;
an inter-frequency or inter-system measurement Srxlev threshold SnonIntraSearchP; or
an inter-frequency or inter-system measurement Squal threshold SnonIntraSearchQ.

For example, the terminal applies the fifth offset value to SnonIntraSearchP or causes Squal to be less likely to meet a condition of being less than or equal to SnonIntraSearchQ, so that the measurement start condition can be met more difficultly, thereby avoiding frequent reselection of the terminal.

In the foregoing implementation, in a case that the terminal considers the priority of the frequency at which the serving cell is located as the highest and the terminal performs cell reselection, the terminal stops considering the priority of the frequency at which the serving cell is located as the highest. In a case that the terminal considers the priority of the frequency at which the serving cell is located as the highest and the terminal performs cell reselection, it indicates that quality of the current serving cell is not good, it is not suitable for the terminal to reselect the serving cell. Therefore, to reduce a possibility that the terminal reselects the serving cell again, the behavior of considering the priority of the frequency at which the serving cell is located as the highest is canceled.

In an implementation, to prevent the terminal from frequently evaluating whether the terminal does not enter the first region or is getting away from the first region, in an implementation, the method may further include: in a case that a first condition is met, the terminal evaluates at least one of the following:
the terminal does not enter the first region;
the terminal is getting away from the first region;
the terminal enters the first region; or
the terminal is getting close to the first region.

The first condition is related to at least one of the following factors:
(1) A first periodicity. That is, the terminal may periodically evaluate whether the terminal does not enter/is getting away from the first region.

The first periodicity may be a fixed periodicity. For example, after the terminal evaluates that the terminal enters/is getting close to the first region or the terminal has not entered/is getting away from the first region, evaluation is performed again after a period of time. The period of time may be represented in a form of a timer. For example, the terminal starts a timer after evaluation is performed, where a length of the timer is the period of time. During running of the timer, the terminal does not need to obtain a reference position of the first cell, and the terminal performs evaluation again when the timer expires. The periodicity may be agreed on in a protocol or configured by the network side.

In some embodiments, the first periodicity may be a non-fixed periodicity, for example, a short periodicity plus a long periodicity. For example, the terminal performs evaluation based on the short periodicity, and after the terminal performs evaluation for N periodicities or a period of time, if the terminal does not enter/is getting away from the first region, the terminal performs evaluation based on the long periodicity. In some embodiments, if the terminal evaluates, based on the long periodicity, that a case that the terminal enters/is getting close to the first region or the terminal has not entered/is getting away from the first region is met, the terminal may perform evaluation based on the short periodicity subsequently.

The period of time may be agreed on in a protocol or configured by the network side, and N may be agreed on in a protocol or configured by the network side.
(2) Starting of measurement on the neighboring cell at the first frequency. For example, after intra-frequency measurement is started, the terminal evaluates whether the terminal enters/is getting close to the first region or the terminal has not entered/is getting away from the first region.
(3) Non-starting of measurement on the neighboring cell at the first frequency. For example, the first frequency is a frequency same as the frequency of the serving cell, a condition of starting measurement on a neighboring cell at the intra-frequency is not met, and the terminal does not start measurement on the neighboring cell at the first frequency.
(4) A signal strength of a serving cell. For example, in a case that a cell selection reception level value Srxlev of the serving cell of the terminal is less than or equal to a first threshold, the terminal evaluates whether the terminal enters/is getting close to the first region or the terminal has not entered/is getting away from the first region.
(5) Signal quality of the serving cell. For example, in a case that a cell selection quality value Squal of the serving cell of the terminal is less than or equal to a second threshold, the terminal evaluates whether the terminal enters/is getting close to the first region or the terminal has not entered/is getting away from the first region.
(6) A relationship between a position of the terminal and the serving cell. For example, in a case that a distance between the terminal and a reference position of the serving cell is greater than or equal to a third threshold, the terminal evaluates whether the terminal enters/is getting close to the first region or the terminal has not entered/is getting away from the first region.

The first condition may be agreed on in a protocol or configured by the network side. It should be noted that, if the protocol does not agree on the first condition, or the network side does not configure the first condition, the terminal may perform evaluation based on an implementation, or the protocol agrees on or the network side configures a minimum requirement that needs to be evaluated by the terminal, and the terminal only needs to meet the minimum requirement.

It should be noted that, the factors deciding the first condition may be independently configured or may be configured in a combined manner, and a relationship among different factors may be an “and” or “or” relationship. For example, evaluation is performed periodically after measurement on the neighboring cell at the first frequency is started. In another example, the terminal starts evaluation in a case that the signal strength or the signal quality of the serving cell is less than or equal to a threshold or a distance between the terminal and a reference point of the serving cell is less than or equal to a threshold.

In an implementation, the method may further include: in a case that a second condition is met, the terminal does not evaluate at least one of the following:
the terminal does not enter the first region;
the terminal is getting away from the first region;
the terminal enters the first region; or
the terminal is getting close to the first region.

The second condition is related to at least one of the following factors:
(1) Execution of cell reselection by the terminal. In a case that cell reselection is performed, the terminal does not evaluate whether the terminal does not enter/is getting away from the first region or the terminal enters/is getting close to the first region. The terminal may perform evaluation based on a configuration of a cell after the reselection.
(2) A signal strength of a serving cell. For example, in a case that an Srxlev of the serving cell of the terminal is greater than or equal to a fourth threshold, the terminal determines that the second condition is met and does not perform the foregoing evaluation. In another example, within a first period after the Srxlev of the serving cell of the terminal is greater than or equal to a sixth threshold, the terminal considers that the second condition is met within the first period and does not perform the foregoing evaluation.
(3) Signal quality of the serving cell. For example, in a case that an Squal of the serving cell of the terminal is greater than or equal to a fifth threshold, the terminal determines that the second condition is met and does not perform the foregoing evaluation. In another example, within a second period after the Squal of the serving cell of the terminal is greater than or equal to a seventh threshold, the terminal considers that the second condition is met within the second period and does not perform the foregoing evaluation.
(4) A relationship between a position of the terminal and the serving cell. For example, in a case that a distance between the terminal and a reference position of the serving cell is less than or equal to an eighth threshold, the terminal determines that the second condition is met and does not perform the foregoing evaluation. In another example, within a third period after the distance between the terminal and the reference position of the serving cell is less than or equal to a ninth threshold, the terminal considers that the second condition is met within the third period and does not perform the foregoing evaluation.

The second condition may be agreed on in a protocol or configured by the network side. It should be noted that, the factors deciding the second condition may be independently configured or configured in a combined manner, and a relationship among different factors may be an “and” or “or” relationship.

In an implementation, that the terminal does not enter the first region or is getting away from the first region includes at least one of the following:
(1) It is determined, based on a position of the terminal, that the terminal does not enter the first region or is getting away from the first region. That is, it may be determined, according to the position of the terminal, that the terminal does not enter the first region or is getting away from the first region.

For example, it is determined that the terminal does not enter the first region in a case that the terminal is not within coverage of the first region. For example, the network side may provide the coverage (for example, latitudes and longitudes) of the first region, and the terminal determines whether the terminal is within the coverage based on positioning.

In another example, in a case that a distance between the terminal and a first reference position is greater than or equal to a first distance threshold, the terminal evaluates that the terminal does not enter the first region, where the first reference position is a reference position of the first region. The first reference position may be configured by the network side or agreed on in a protocol, the first distance threshold may be configured by the network side or agreed on in a protocol, and there may be one or more first reference positions.

In another example, it is determined that the terminal is getting away from the first region in a case that the terminal moves from the inside of the coverage of the first region to the outside of the coverage of the first region. For example, the network side may provide the coverage (for example, latitudes and longitudes) of the first region, and the terminal determines that the terminal moves from the inside of the coverage of the first region to the outside of the coverage of the first region based on positioning and evaluates that the terminal is getting away from the first region.

In another example, within a third period, it is determined that the terminal is getting away from the first region in a case that a variation of the distance between the terminal and the first reference position is greater than or equal to a second distance threshold and the distance between the terminal and the first reference position at a first moment is increased relative to the distance between the terminal and the first reference position at a second moment, where the first moment is an end point of the third period, the second moment is a start point of the third period, and the first reference position is a reference position of the first region. That is, within the third period, in a case that the distance between the terminal and the first reference position is increasingly large and the variation of the distance is greater than or equal to the second distance threshold, the terminal evaluates that the terminal is getting away from the first region.

The third period may be agreed on in a protocol or may be configured by the network side. For example, the third period may be 1 s. The second distance threshold may be agreed on in a protocol or may be configured by the network side.
(2) It is determined, based on signal quality of a cell associated with the first region, that the terminal does not enter the first region or is getting away from the first region. The cell associated with the first region is the at least one first cell or a cell at the at least one third frequency.

For example, it is determined that the terminal does not enter the first region in a case that an Squal of a third cell is less than or equal to a tenth threshold. The third cell is a cell associated with the first region. For example, if the first region is associated with the first cell, in a case that the signal quality of the first cell is less than or equal to a threshold, the terminal evaluates that the terminal does not enter the first region.

In another example, within a fifth period, it is determined that the terminal is getting away from the first region in a case that a variation of the Squal of the third cell is greater than or equal to an eleventh threshold and the Squal of the third cell at a fifth moment is decreased relative to the Squal of the third cell at a sixth moment, where the fifth moment is an end point of the fifth period, and the sixth moment is a start point of the fifth period. That is, within the fifth period, in a case that the signal quality of the first cell associated with the first region is increasingly poor and the variation is greater than or equal to the eleventh threshold, the terminal evaluates that the terminal is getting away from the first region.

The fifth period may be agreed on in a protocol or may be configured by the network side. For example, the fifth period may be 1 s. The tenth threshold and/or the eleventh threshold may be agreed on in a protocol or may be configured by the network side.

It should be noted that, in a case that the third cell is one cell, the signal quality/the signal strength is the signal strength of the third cell; and in a case that the third cell includes a plurality of cells, the signal strength may be an average value, a maximum value, or a minimum value of the signal quality/the signal strengths of the plurality of third cells.
(3) It is determined, based on a signal strength of the cell associated with the first region, that the terminal does not enter the first region or is getting away from the first region. The cell associated with the first region is the at least one first cell or a cell at the at least one third frequency.

For example, it is determined that the terminal does not enter the first region in a case that an Srxlev of a third cell is less than or equal to a fourteenth threshold. For example, the terminal evaluates that the terminal does not enter the first region in a case that the Srxlev of the third cell associated with the first region is less than or equal to a threshold.

In another example, within a seventh period, it is determined that the terminal is getting away from the first region in a case that a variation of the Srxlev of the third cell is greater than or equal to a fifteenth threshold and the Squal of the third cell at a ninth moment is decreased relative to the Squal of the third cell at a tenth moment, where the ninth moment is an end point of the seventh period, and the tenth moment is a start point of the seventh period. That is, within the seventh period, in a case that the signal strength of the third cell is increasingly weak and the variation is greater than or equal to the fifteenth threshold, the terminal evaluates that the terminal is getting away from the first region.

The seventh period may be agreed on in a protocol or may be configured by the network side. For example, the seventh period may be 1 s. The fourteenth threshold and/or the fifteenth threshold may be agreed on in a protocol or may be configured by the network side.

It should be noted that, in a case that the third cell is one cell, the signal quality/the signal strength is the signal quality of the third cell; and in a case that the third cell includes a plurality of cells, the signal quality may be an average value, a maximum value, or a minimum value of the signal quality/the signal strengths of the plurality of third cells.

In an implementation, that the terminal enters the first region or is getting close to the first region includes at least one of the following:
(1) It is determined, based on a position of the terminal, that the terminal enters the first region or is getting close to the first region.

For example, it is determined that the terminal enters the first region in a case that the terminal is within coverage of the first region. For example, the network side may provide the coverage (for example, latitudes and longitudes) of the first region, and the terminal determines whether the terminal is within the coverage based on positioning. If the terminal is within the coverage, the terminal evaluates that the terminal enters the first region.

In another example, it is determined that the terminal enters the first region in a case that a distance between the terminal and a first reference position is less than or equal to a third distance threshold, where the first reference position is a reference position of the first region; and the first reference position is configured by the network side, the first distance threshold is configured by the network side or agreed on in a protocol, and there may be one or more first reference positions.

In another example, it is determined that the terminal is getting close to the first region in a case that the terminal moves from the outside of the coverage of the first region to the inside of the coverage of the first region.

In another example, within a fourth period, it is determined that the terminal is getting close to the first region in a case that a variation of the distance between the terminal and the first reference position is greater than or equal to a second distance threshold and the distance between the terminal and the first reference position at a third moment is decreased relative to the distance between the terminal and the first reference position at a fourth moment, where the third moment is an end point of the fourth period, the fourth moment is a start point of the fourth period, and the first reference position is a reference position of the first region. That is, within the fourth period, in a case that the distance between the terminal and the first reference position is increasingly small and the variation is greater than or equal to the second distance threshold, the terminal evaluates that the terminal is getting close to the first region.

The fourth period may be agreed on in a protocol or may be configured by the network side.
(2) It is determined, based on signal quality of a cell associated with the first region, that the terminal enters the first region or is getting close to the first region. The cell associated with the first region is the at least one first cell or a cell at the at least one third frequency.

For example, it is determined that the terminal enters the first region in a case that an Squal of a third cell is greater than or equal to a twelfth threshold. The third cell is a cell associated with the first region.

In another example, within a sixth period, it is determined that the terminal is getting close to the first region in a case that a variation of the Squal of the third cell is greater than or equal to a thirteenth threshold and the Squal of the third cell at a seventh moment is increased relative to the Squal of the third cell at an eighth moment, where the seventh moment is an end point of the sixth period, and the eighth moment is a start point of the sixth period; and the third cell is a cell associated with the first region. That is, within the sixth period, in a case that the Squal of the third cell is increasingly large and the variation is greater than or equal to the thirteenth threshold, the terminal evaluates that the terminal is getting close to the first region.

The sixth period may be agreed on in a protocol or may be configured by the network side. For example, the sixth period may be 1 s. The twelfth threshold and/or the thirteenth threshold may be agreed on in a protocol or may be configured by the network side.

It should be noted that, in a case that the third cell is one cell, the signal quality is the signal strength of the third cell; and in a case that the third cell includes a plurality of cells, the signal strength may be an average value, a maximum value, or a minimum value of the signal quality of the plurality of third cells.
(3) It is determined, based on a signal strength of the cell associated with the first region, that the terminal enters the first region or is getting close to the first region. The cell associated with the first region is the at least one first cell or a cell at the at least one third frequency.

For example, it is determined that the terminal does not enter the first region in a case that an Srxlev of a third cell is greater than or equal to a sixteenth threshold. The third cell is a cell associated with the first region.

In another example, within an eighth period, it is determined that the terminal is getting close to the first region in a case that a variation of the Srxlev of the third cell is greater than or equal to a seventeenth threshold and the Squal of the third cell at an eleventh moment is increased relative to the Squal of the third cell at a twelfth moment, where the eleventh moment is an end point of the eighth period, and the twelfth moment is a start point of the eighth period; and the third cell is a cell associated with the first region. That is, within the eighth period, in a case that the Srxlev of the third cell is increasingly large and the variation is greater than or equal to the seventeenth threshold, the terminal evaluates that the terminal is getting close to the first region.

The eighth period may be agreed on in a protocol or may be configured by the network side. For example, the eighth period may be 1 s. The sixteenth threshold and/or the seventeenth threshold may be agreed on in a protocol or may be configured by the network side.

It should be noted that, in a case that the third cell is one cell, the signal strength is the signal strength of the third cell; and in a case that the third cell includes a plurality of cells, the signal strength may be an average value, a maximum value, or a minimum value of the signal strengths of the plurality of third cells.

In the foregoing various possible implementations, before it is determined that the terminal does not enter the first region or is getting away from the first region and/or it is determined that the terminal enters the first region or is getting close to the first region, the method further includes: obtaining a network type of the third cell, where the network type of the third cell is the first network type. That is, before the terminal evaluates whether the terminal does not enter/is getting away from the first region or whether the terminal enters/is getting close to the first region according to the signal quality and/or the signal strength of the third cell, the terminal needs to determine that the network type of the third cell is the first network type.

According to the technical solution provided in the embodiments of this application, the terminal can exclude or reduce measurement on neighboring cells at some frequencies, thereby achieving an objective of saving power.

FIG. 5 is a flowchart of a measurement control policy configuration method according to an embodiment of this application. As shown in FIG. 5, the method 500 may include the following step.

S510. A network side device configures a measurement control policy for a terminal, where the measurement control policy indicates the terminal to skip performing measurement on a neighboring cell at a first frequency or perform relaxation measurement on the neighboring cell at the first frequency in a case that the terminal does not enter a first region or is getting away from the first region. The measurement control policy is the same as the measurement control policy in the method 300, and for details, reference may be made to the related description in the method 300, which are not described herein.

In an implementation, the method further includes: the network side device configures related information of the first region for the terminal. The related information of the first region is the same as the related information of the first region in the method 300, and for details, reference may be made to the related description in the method 300, which are not described herein.

According to the solution provided in the embodiments of this application, the network side device may configure the measurement control policy for the terminal, so that measurement of the terminal on neighboring cells at some frequencies can be excluded or reduced, thereby achieving an objective of saving power.

An entity executing the measurement control method provided in the embodiments of this application may be a measurement control apparatus. An example in which a measurement control apparatus executes the measurement control method is used in the embodiments of this application to describe the measurement control apparatus provided in the embodiments of this application.

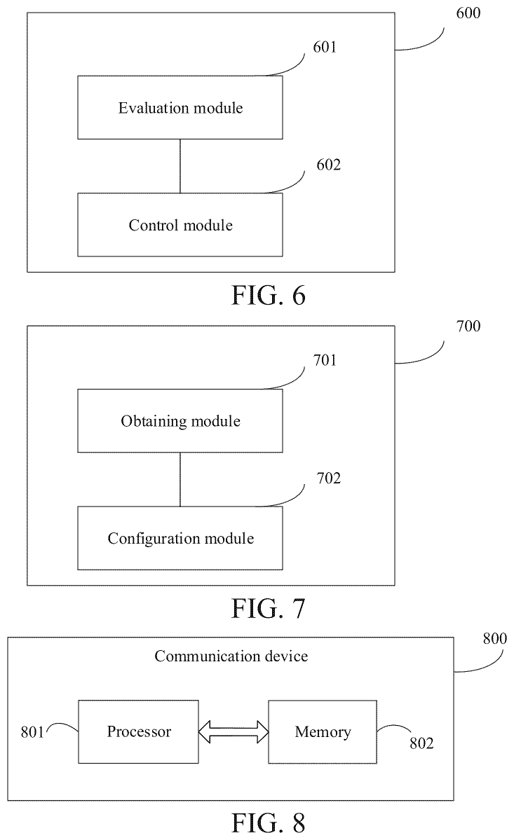

FIG. 6 is a schematic structural diagram of a measurement control apparatus according to an embodiment of this application. As shown in FIG. 6, the apparatus 600 mainly includes: an evaluation module 601 and a control module 602.

In the embodiments of this application, the evaluation module 601 is configured to evaluate whether a terminal does not enter a first region or is getting away from the first region; and the control module 602 is configured to control the terminal to skip performing measurement on a neighboring cell at a first frequency or perform relaxation measurement on the neighboring cell at the first frequency in a case that the terminal does not enter the first region or is getting away from the first region, where the first region is within a coverage range of a network of a first network type, the first frequency is at least one of a second frequency associated with the first region, and the second frequency is a frequency used for deployment of the network of the first network type.

In an implementation, the control module 602 is further configured to start measurement on the neighboring cell at the first frequency.

In an implementation, the first region includes at least one of the following:
a region associated with at least one first cell, where a network type of the first cell is the first network type; or
a region associated with at least one third frequency, where the third frequency is a frequency used for deployment of the network of the first network type.

In an implementation, in a case that the first region includes the region associated with the at least one first cell, the second frequency is a frequency at which the at least one first cell is located; or in a case that the first region includes the region associated with the at least one third frequency, the second frequency is the at least one third frequency.

In an implementation, the control module 602 is further configured to perform a process of obtaining related information of the first region.

In an implementation, the control module is further configured to control, in a case of not obtaining the related information of the first region, the terminal to perform one of the following behaviors:
performing measurement on the neighboring cell at the first frequency;
skipping performing measurement on the neighboring cell at the first frequency; or
performing relaxation measurement on the neighboring cell at the first frequency.

In an implementation, that the control module 602 performs the process of obtaining the related information of the first region includes:
performing the process of obtaining the related information of the first region, and obtaining preconfigured related information of the first region; or
performing the process of obtaining the related information of the first region, and obtaining related information that is configured by a network side and of the first region.

In an implementation, the control module 602 is further configured to obtain a measurement control policy agreed on in a protocol or configured by a network, where the measurement control policy indicates to skip performing measurement on the neighboring cell at the first frequency or perform relaxation measurement on the neighboring cell at the first frequency in a case that the terminal does not enter the first region or is getting away from the first region.

In an implementation, the first frequency includes at least one of the following:
a dedicated frequency used for deployment of the network of the first network type; or
a shared frequency used for deployment of the network of the first network type and a network of a second network type, where the second network type is different from the first network type.

In an implementation, that the terminal skips performing measurement on the neighboring cell at the first frequency or performs relaxation measurement on the neighboring cell at the first frequency includes at least one of the following:
in a case that the first frequency includes the dedicated frequency used for deployment of the network of the first network type and the terminal does not enter the first region or is getting away from the first region, the terminal skips performing measurement on the neighboring cell at the first frequency; or
in a case that the first frequency includes the shared frequency used for deployment of the network of the first network type and the network of the second network type and the terminal does not enter the first region or is getting away from the first region, the terminal performs relaxation measurement on the neighboring cell at the first frequency.

In an implementation, the evaluation module 601 is further configured to evaluate whether the terminal enters the first region or is getting close to the first region; and the control module 602 is further configured to control, in a case that the terminal enters the first region or is getting close to the first region, the terminal to preferentially select or preferentially reselect a cell corresponding to the first network type.

In an implementation, that the terminal preferentially selects or preferentially reselects the cell corresponding to the first network type includes at least one of the following:
the terminal starts measurement on the second frequency;
the terminal sets a priority of the second frequency to the highest;
the terminal increases the priority of the second frequency by a first offset value;
the terminal increases a value of a parameter related to a reselection criterion of a second cell by a second offset value;
the terminal decreases a threshold related to the reselection criterion of the second cell by a third offset value; or
the terminal applies a parameter related to a cell reselection criterion dedicated to the first network type to perform cell reselection, where
the parameter related to the reselection criterion includes at least one of the following:
a cell selection reception level value Srxlev;
a cell selection quality value Squal; or
a cell R value;
the threshold related to the reselection criterion includes at least one of the following:
an Srxlev threshold ThreshX, HighP used by the terminal when the terminal reselects an inter-frequency or inter-system frequency having a higher priority than a current serving frequency;
an Squal threshold ThreshX, HighQ used by the terminal when the terminal reselects the inter-frequency or inter-system frequency having a higher priority than the current serving frequency;
an Srxlev threshold ThreshX, LowP used by the terminal when the terminal reselects and reselects an inter-frequency or inter-system frequency having a lower priority than the current serving frequency; or
an Squal threshold ThreshX, LowQ used by the terminal when the terminal reselects and reselects the inter-frequency or inter-system frequency having a lower priority than the current serving frequency; and
the second cell includes the first cell associated with the first region.

In an implementation, in a case that a network type of a serving cell of the terminal is the first network type, that the terminal preferentially selects or preferentially reselects a cell corresponding to the first network type includes at least one of the following:
the terminal considers a priority of a frequency at which the serving cell is located as the highest;
the terminal increases a value of a parameter related to a measurement criterion by a fourth offset value;
the terminal applies a parameter related to a measurement criterion dedicated to the first network type; or
the terminal decreases a threshold related to the measurement criterion by a fifth offset value, where
the parameter related to the measurement criterion includes at least one of the following:
a cell selection reception level value Srxlev; or
a cell selection quality value Squal; and
the threshold related to the measurement criterion includes at least one of the following:
an intra-frequency measurement Srxlev threshold SIntraSearchP;
an intra-frequency measurement Squal threshold SIntraSearchQ;
an inter-frequency or inter-system measurement Srxlev threshold SnonIntraSearchP; or
an inter-frequency or inter-system measurement Squal threshold SnonIntraSearchQ.

In an implementation, in a case that the terminal considers the priority of the frequency at which the serving cell is located as the highest and the terminal performs cell reselection, the control module 602 is further configured to control the terminal to stop considering the priority of the frequency at which the serving cell is located as the highest.

In an implementation, in a case that a first condition is met, the evaluation module 601 is configured to evaluate at least one of the following:
the terminal does not enter the first region;
the terminal is getting away from the first region;
the terminal enters the first region; or
the terminal is getting close to the first region, where
the first condition is related to at least one of the following:
a first periodicity;
starting of measurement on the neighboring cell at the first frequency;
non-starting of measurement on the neighboring cell at the first frequency;
a signal strength of a serving cell;
signal quality of the serving cell; or
a relationship between a position of the terminal and the serving cell.

In an implementation, in a case that the first condition is related to the signal strength of the serving cell, that the first condition is met includes: a cell selection reception level value Srxlev of the serving cell of the terminal is less than or equal to a first threshold;
in a case that the first condition is related to the signal quality of the serving cell, that the first condition is met includes: a cell selection quality value Squal of the serving cell of the terminal is less than or equal to a second threshold; or
in a case that the first condition is related to the relationship between the position of the terminal and the serving cell, that the first condition is met includes: a distance between the terminal and a reference position of the serving cell is greater than or equal to a third threshold.

In an implementation, in a case that a second condition is met, the evaluation module 601 is configured to not evaluate at least one of the following:
the terminal does not enter the first region;
the terminal is getting away from the first region;
the terminal enters the first region; or
the terminal is getting close to the first region, where
the second condition is related to at least one of the following:
execution of cell reselection by the terminal;
a signal strength of a serving cell;
signal quality of the serving cell; or
a relationship between a position of the terminal and the serving cell.

In an implementation, in a case that the second condition is related to the signal strength of the serving cell, that the second condition is met includes one of the following:
an Srxlev of the serving cell of the terminal is greater than or equal to a fourth threshold; or
within a first period after the Srxlev of the serving cell of the terminal is greater than or equal to a sixth threshold;
in a case that the second condition is related to the signal quality of the serving cell, that the second condition is met includes one of the following:
an Squal of the serving cell of the terminal is greater than or equal to a fifth threshold; or
within a second period after the Squal of the serving cell of the terminal is greater than or equal to a seventh threshold; or
in a case that the second condition is related to the relationship between the position of the terminal and the serving cell, that the second condition is met includes one of the following:
a distance between the terminal and a reference position of the serving cell is less than or equal to an eighth threshold; or
within a third period after the distance between the terminal and the reference position of the serving cell is less than or equal to a ninth threshold.

In an implementation, that the evaluation module 601 evaluates that the terminal does not enter the first region or is getting away from the first region includes at least one of the following:
determining, based on a position of the terminal, that the terminal does not enter the first region or is getting away from the first region;
determining, based on signal quality of a cell associated with the first region, that the terminal does not enter the first region or is getting away from the first region;
determining, based on a signal strength of the cell associated with the first region, that the terminal does not enter the first region or is getting away from the first region, where
the cell associated with the first region is the at least one first cell or a cell at the at least one third frequency.

In an implementation, that the evaluation module 601 evaluates that the terminal enters the first region or is getting close to the first region includes at least one of the following:
determining, based on a position of the terminal, that the terminal enters the first region or is getting close to the first region;
determining, based on signal quality of a cell associated with the first region, that the terminal enters the first region or is getting close to the first region; or
determining, based on a signal strength of the cell associated with the first region, that the terminal enters the first region or is getting close to the first region, where
the cell associated with the first region is the at least one first cell or a cell at the at least one third frequency.

In an implementation, that the evaluation module 601 determines, based on the position of the terminal, that the terminal does not enter the first region or is getting away from the first region includes at least one of the following:
determining that the terminal does not enter the first region in a case that the terminal is not within coverage of the first region;
determining that the terminal does not enter the first region in a case that a distance between the terminal and a first reference position is greater than or equal to a first distance threshold, where the first reference position is a reference position of the first region;
determining that the terminal is getting away from the first region in a case that the terminal moves from the inside of the coverage of the first region to the outside of the coverage of the first region; or
within a third period, determining that the terminal is getting away from the first region in a case that a variation of the distance between the terminal and the first reference position is greater than or equal to a second distance threshold and the distance between the terminal and the first reference position at a first moment is increased relative to the distance between the terminal and the first reference position at a second moment, where the first moment is an end point of the third period, the second moment is a start point of the third period, and the first reference position is a reference position of the first region.

In an implementation, that the evaluation module 601 determines, based on the position of the terminal, that the terminal enters the first region or is getting close to the first region includes at least one of the following:
determining that the terminal enters the first region in a case that the terminal is within coverage of the first region;
determining that the terminal enters the first region in a case that a distance between the terminal and a first reference position is less than or equal to a third distance threshold, where the first reference position is a reference position of the first region;
determining that the terminal is getting close to the first region in a case that the terminal moves from the outside of the coverage of the first region to the inside of the coverage of the first region; or
within a fourth period, determining that the terminal is getting close to the first region in a case that a variation of the distance between the terminal and the first reference position is greater than or equal to a second distance threshold and the distance between the terminal and the first reference position at a third moment is decreased relative to the distance between the terminal and the first reference position at a fourth moment, where the third moment is an end point of the fourth period, the fourth moment is a start point of the fourth period, and the first reference position is a reference position of the first region.

In an implementation, that the evaluation module 601 determines, based on the signal quality, that the terminal does not enter the first region or is getting away from the first region includes at least one of the following:
determining that the terminal does not enter the first region in a case that an Squal of a third cell is less than or equal to a tenth threshold; or
within a fifth period, determining that the terminal is getting away from the first region in a case that a variation of the Squal of the third cell is greater than or equal to an eleventh threshold and the Squal of the third cell at a fifth moment is decreased relative to the Squal of the third cell at a sixth moment, where the fifth moment is an end point of the fifth period, and the sixth moment is a start point of the fifth period; and
the third cell is a cell associated with the first region.

In an implementation, that the evaluation module 601 determines, based on the signal quality, that the terminal enters the first region or is getting close to the first region includes at least one of the following:
determining that the terminal enters the first region in a case that an Squal of a third cell is greater than or equal to a twelfth threshold; or
within a sixth period, determining that the terminal is getting close to the first region in a case that a variation of the Squal of the third cell is greater than or equal to a thirteenth threshold and the Squal of the third cell at a seventh moment is increased relative to the Squal of the third cell at an eighth moment, where the seventh moment is an end point of the sixth period, and the eighth moment is a start point of the sixth period; and
the third cell is a cell associated with the first region.

In an implementation, that the evaluation module 601 determines, based on the signal strength, that the terminal does not enter the first region or is getting away from the first region includes at least one of the following:
determining that the terminal does not enter the first region in a case that an Srxlev of a third cell is less than or equal to a fourteenth threshold; or
within a seventh period, determining that the terminal is getting away from the first region in a case that a variation of the Srxlev of the third cell is greater than or equal to a fifteenth threshold and the Squal of the third cell at a ninth moment is decreased relative to the Squal of the third cell at a tenth moment, where the ninth moment is an end point of the seventh period, and the tenth moment is a start point of the seventh period; and
the third cell is a cell associated with the first region.

In an implementation, that the evaluation module 601 determines, based on the signal strength, that the terminal enters the first region or is getting close to the first region includes at least one of the following:
determining that the terminal does not enter the first region in a case that an Srxlev of a third cell is greater than or equal to a sixteenth threshold; or
within an eighth period, determining that the terminal is getting close to the first region in a case that a variation of the Srxlev of the third cell is greater than or equal to a seventeenth threshold and the Squal of the third cell at an eleventh moment is increased relative to the Squal of the third cell at a twelfth moment, where the eleventh moment is an end point of the eighth period, and the twelfth moment is a start point of the eighth period; and
the third cell is a cell associated with the first region.

In an implementation, before it is determined that the terminal does not enter the first region or is getting away from the first region and/or it is determined that the terminal enters the first region or is getting close to the first region, the evaluation module 601 is further configured to obtain a network type of the third cell, where the network type of the third cell is the first network type.

The measurement control apparatus in the embodiments of this application may be an electronic device, for example, an electronic device having an operating system, or may be a component in the electronic device, for example, an integrated circuit or a chip. The electronic device may be a terminal or may be another device other than the terminal. For example, the terminal may include, but not limited to, the types of the terminal 11 listed above, and the another device may be a server, a Network Attached Storage (NAS), or the like. This is not specifically limited in the embodiments of this application.

The measurement control apparatus provided in the embodiments of this application can implement the processes implemented in the method embodiment of FIG. 3 and achieve the same technical effects. To avoid repetition, details are not described herein.

FIG. 7 is a schematic structural diagram of a measurement control policy configuration apparatus according to an embodiment of this application. As shown in FIG. 7, the apparatus 700 mainly includes: an obtaining module 701 and a configuration module 702.

In the embodiments of this application, the obtaining module 701 is configured to obtain a measurement control policy of a terminal, where the measurement control policy indicates the terminal to skip performing measurement on a neighboring cell at a first frequency or perform relaxation measurement on the neighboring cell at the first frequency in a case that the terminal does not enter a first region or is getting away from the first region; and the configuration module 702 is configured to configure the measurement control policy for the terminal.

In an implementation, the configuration module 702 is further configured to configure related information of the first region for the terminal.

The measurement control policy configuration apparatus in the embodiments of this application may be an electronic device, for example, an electronic device having an operating system, or may be a component in the electronic device, for example, an integrated circuit or a chip. The electronic device may be a network side device. For example, the network side device may include, but not limited to, the types of the network side device 12 listed above.

The measurement control policy configuration apparatus provided in the embodiments of this application can implement the processes implemented in the method embodiment of FIG. 5 and achieve the same technical effects. To avoid repetition, details are not described herein.

As shown in FIG. 8, an embodiment of this application further provides a communication device 800, including a processor 801 and a memory 802, where the memory 802 stores a program or an instruction executable on the processor 801. For example, when the communication device 800 is a terminal, when the program or the instruction is executed by the processor 801, the steps of the measurement control method embodiments are implemented, and the same technical effects can be achieved. When the communication device 800 is a network side device, when the program or the instruction is executed by the processor 801, the steps of the measurement control policy configuration method embodiments are implemented, and the same technical effects can be achieved. To avoid repetition, details are described herein.

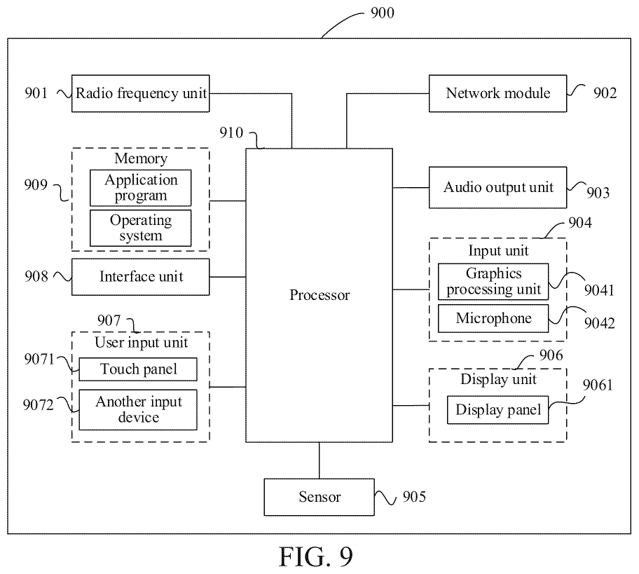

An embodiment of this application further provides a terminal, including a processor and a communication interface, where the processor is configured to implement the steps of the measurement control method embodiments, and the communication interface is configured to communicate with an external device. The terminal embodiment corresponds to the foregoing method embodiments of the terminal side, so that the implementation processes and the implementations of the foregoing method embodiments may all be applied to the terminal embodiment, and the same technical effects can be achieved. FIG. 9 is a schematic structural diagram of hardware of a terminal implementing various embodiments of this application.

The terminal 900 includes, but is not limited to, at least some components of a radio frequency unit 901, a network module 902, an audio output unit 903, an input unit 904, a sensor 905, a display unit 906, a user input unit 907, an interface unit 908, a memory 909 and power a processor 910.

A person skilled in the art may understand that the terminal 900 may further include a power supply (such as a battery) for supplying power to the components. The power supply may be logically connected to the processor 910 by a power management system, thereby implementing functions such as charging, discharging, and power consumption management by using the power management system. The terminal structure shown in FIG. 9 does not constitute a limitation on the terminal, and the terminal may include more or fewer components than those shown in the figure, or some components may be combined, or a different component deployment may be used.

It should be understood that, in the embodiments of this application, the input unit 904 may include a Graphics Processing Unit (GPU) 9041 and a microphone 9042. The GPU 9041 performs processing on image data of a static picture or a video that is obtained by an image acquisition device (for example, a camera) in a video acquisition mode or an image acquisition mode. The display unit 906 may include a display panel 9061. The display panel 9061 may be configured in the form of a liquid crystal display, an organic light-emitting diode, or the like. The user input unit 907 includes at least one of a touch panel 9071 and another input device 9072. The touch panel 9071 is also referred to as a touch screen. The touch panel 9071 may include two parts: a touch detection apparatus and a touch controller. The another input device 9072 may include, but not limited to, a physical keyboard, a functional key (such as a volume control key or a switch key), a track ball, a mouse, and a joystick, which are not described herein in detail.

In the embodiments of this application, after receiving downlink data from a network side device, the radio frequency unit 901 sends the downlink data to the processor 910 for processing. In addition, the radio frequency unit 901 sends uplink data to the network side device. Generally, the radio frequency unit 901 includes, but is not limited to, an antenna, an amplifier, a transceiver, a coupler, a low noise amplifier, a duplexer, and the like.

The memory 909 may be configured to store a software program or an instruction and various data. The memory 909 may mainly include a first storage region storing the program or the instruction and a second storage region storing the data. The first storage region may store an operating system, an application program or an instruction required by at least one function (for example, a sound playback function and an image display function), and the like. In addition, the memory 909 may include a volatile memory or a non-volatile memory, or the memory 909 may include both a volatile memory and a non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), and a Direct Rambus RAM (DRRAM). The memory 909 in the embodiments of this application includes, but is not limited to, these memories and any other memory of a suitable type.

The processor 910 may include one or more processing units. In some embodiments, the processor 910 integrates an application processor and a modem processor, where the application processor mainly processes operations involving an operating system, a user interface, an application program, and the like, and the modem processor mainly processes a wireless communication signal, for example, a baseband processor. It may be understood that, the modem processor may not be integrated into the processor 910.

The processor 910 is configured to: evaluate whether a terminal does not enter a first region or is getting away from the first region; and control the terminal to skip performing measurement on a neighboring cell at a first frequency or perform relaxation measurement on the neighboring cell at the first frequency in a case that the terminal does not enter the first region or is getting away from the first region, where the first region is within a coverage range of a network of a first network type, the first frequency is at least one of a second frequency associated with the first region, and the second frequency is a frequency used for deployment of the network of the first network type.

An embodiment of this application further provides a network side device, including a processor and a communication interface, where the processor is configured to implement the steps of the measurement control policy configuration method embodiments, and the communication interface is configured to communicate with an external device. The network side device embodiment corresponds to the foregoing method embodiments of the network side device, so that the implementation processes and the implementations of the foregoing method embodiments may all be applied to the network side device embodiment, and the same technical effects can be achieved.

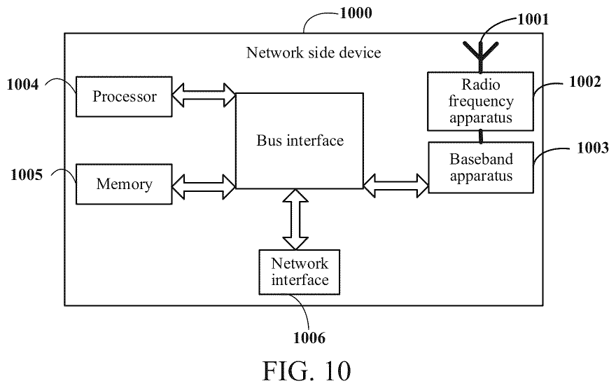

An embodiment of this application further provides a network side device. As shown in FIG. 10, the network side device 1000 includes: an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes to-be-sent information and sends the to-be-sent information to the radio frequency apparatus 1002, and the radio frequency apparatus 1002 processes the received information and sends the information out through the antenna 1001.

The method performed by the network side device in the foregoing embodiments may be implemented in the baseband apparatus 1003, and the baseband apparatus 1003 includes a baseband processor.

For example, the baseband apparatus 1003 may include at least one baseband plate, and a plurality of chips are arranged on the baseband plate. As shown in FIG. 10, one of the chips is, for example, a baseband processor, and is connected to the memory 1005 through a bus interface, to invoke a program in the memory 1005 to perform the operations of the network side shown in the foregoing method embodiments.

The network side device may further include a network interface 1006, and the interface is, for example, a common public radio interface (CPRI).

The network side device 1000 in the embodiments of the present application further includes an instruction or a program stored in the memory 1005 and executable on the processor 1004, and the processor 1004 invokes the instruction or the program in the memory 1005 to perform the method performed by the modules in FIG. 7 and achieves the same technical effects, to avoid repetition, details are not described herein.

An embodiment of this application further provides a readable storage medium, having a program or an instruction stored therein, where when the program or the instruction is executed by a processor, the processes of the measurement control method embodiments are implemented, or the processes of the measurement control policy configuration method embodiments are implemented, and the same technical effects can be achieved. To avoid repetition, details are not described herein.

The processor is the processor in the terminal described in the foregoing embodiments. The readable storage medium may be non-transient or non-volatile. The readable storage medium may include a computer-readable storage medium, for example, a computer read-only memory ROM, a random access memory RAM, a magnetic disk, an optical disc, or the like.

An embodiment of this application further provides a chip. The chip includes a processor and a communication interface, the communication interface is coupled to the processor, and the processor is configured to execute a program or an instruction, to implement the processes of the measurement control method embodiments or the processes of the measurement control policy configuration method embodiments, and the same technical effects can be achieved. To avoid repetition, details are not described herein.

It should be understood that, the chip provided in the embodiments of this application may also be referred to as a system-level chip, a system chip, a chip system, a system on chip, or the like.

An embodiment of this application further provides a computer program/program product, the computer program/program product being stored in a storage medium, where when the computer program/program product is executed by at least one processor, the processes of the measurement control method embodiments are implemented, or the processes of the measurement control policy configuration method embodiments are implemented, and the same technical effects can be achieved. To avoid repetition, details are not described herein.

An embodiment of this application further provides a measurement control system, including a terminal and a network side device, where the terminal may be configured to perform the steps of the measurement control method described above, and the network side device may be configured to perform the steps of measurement control policy configuration method described above.

It should be noted that, the term “include”, “comprise”, or any other variant thereof in this specification is intended to cover non-exclusive inclusion, so that a process, a method, an object, or an apparatus that includes a series of elements not only includes the elements, but also includes other elements that are not expressly listed, or may further include elements that are inherent to the process, the method, the object, or the apparatus. Without more limitations, an element defined by a sentence “including one . . . ” does not exclude existence of other same elements in the process, the method, the object, or the apparatus that includes the element. In addition, it should be noted that a scope of the method and the apparatus in the implementations of this application is not limited to performing functions according to a sequence that is shown or discussed, but may further include performing functions in a substantially simultaneous manner or in a reversed sequence according to the functions involved. For example, the described method may be performed in a different order than a described order, and various steps may be added, omitted, or combined. In addition, features described with reference to some examples may be combined in other examples.

Through the description of the foregoing implementations, a person skilled in the art may clearly understand that the method according to the foregoing embodiments may be implemented by software and a necessary general hardware platform, and may be implemented by hardware, but in many cases, the former manner is a better implementation. Based on such an understanding, the technical solutions of this application essentially or the part contributing to the related art may be implemented in a form of a computer software product. The computer software product is stored in a storage medium (such as a ROM/RAM, a magnetic disk, or an optical disc) and includes several instructions for instructing a terminal (which may be a mobile phone, a computer, a server, an air conditioner, a network device, or the like) to perform the methods described in the embodiments of this application.

The embodiments of this application are described above with reference to the accompanying drawings. However, this application is not limited to the specific implementations described above, and the specific implementations described above are only exemplary and not limitative. A person of ordinary skill in the art may make various variations under the teaching of this application without departing from the spirit of this application and the protection scope of the claims, and such variations shall all fall within the protection scope of this application.

What is claimed is:

1. A method of measurement control, comprising:
when a terminal does not enter a first region or is getting away from the first region, skipping performing, by the terminal, measurement on a neighboring cell at a first frequency,
wherein the first region is within a coverage range of a network of a first network type, the first frequency is at least one of a second frequency associated with the first region, and the second frequency is a frequency used for deployment of the network of the first network type.

2. The method according to claim 1, wherein the terminal resides in a Non-Terrestrial Network (NTN) cell, and the neighboring cell comprises a Terrestrial Network (TN) cell.

3. The method according to claim 1, wherein the first region comprises:
a region associated with at least one third frequency, wherein the third frequency is a frequency used for deployment of the network of the first network type.

4. The method according to claim 3, wherein the second frequency is the at least one third frequency.

5. The method according to claim 1, wherein before the skipping performing, by the terminal, measurement on a neighboring cell at a first frequency, the method further comprises:
performing, by the terminal, a process of obtaining related information of the first region.

6. The method according to claim 5, wherein the performing, by the terminal, a process of obtaining related information of the first region comprises:
performing, by the terminal, the process of obtaining the related information of the first region, and obtaining preconfigured related information of the first region; or
performing, by the terminal, the process of obtaining the related information of the first region, and obtaining related information that is configured by a network side and of the first region.

7. The method according to claim 1, wherein the first frequency comprises at least one of the following:
a dedicated frequency used for deployment of the network of the first network type; or
a shared frequency used for deployment of the network of the first network type and a network of a second network type, wherein the second network type is different from the first network type.

8. The method according to claim 3, further comprising:
when the terminal enters the first region or is getting close to the first region, preferentially selecting or preferentially reselecting, by the terminal, a cell corresponding to the first network type.

9. The method according to claim 3, wherein that the terminal does not enter the first region or is getting away from the first region comprises at least one of the following:
determining, based on a position of the terminal, that the terminal does not enter the first region or is getting away from the first region;
determining, based on signal quality of a cell associated with the first region, that the terminal does not enter the first region or is getting away from the first region; or
determining, based on a signal strength of the cell associated with the first region, that the terminal does not enter the first region or is getting away from the first region,
wherein the cell associated with the first region is the at least one first cell or a cell at the at least one third frequency.

10. The method according to claim 8, wherein that the terminal enters the first region or is getting close to the first region comprises at least one of the following:
determining, based on a position of the terminal, that the terminal enters the first region or is getting close to the first region;
determining, based on signal quality of a cell associated with the first region, that the terminal enters the first region or is getting close to the first region; or
determining, based on a signal strength of the cell associated with the first region, that the terminal enters the first region or is getting close to the first region,
wherein the cell associated with the first region is the at least one first cell or a cell at the at least one third frequency.

11. The method according to claim 9, wherein the determining, based on a position of the terminal, that the terminal does not enter the first region or is getting away from the first region comprises at least one of the following:
determining that the terminal does not enter the first region when the terminal is not within coverage of the first region;
determining that the terminal does not enter the first region when a distance between the terminal and a first reference position is greater than or equal to a first distance threshold, wherein the first reference position is a reference position of the first region;
determining that the terminal is getting away from the first region when the terminal moves from the inside of the coverage of the first region to the outside of the coverage of the first region; or
within a third period, determining that the terminal is getting away from the first region when a variation of the distance between the terminal and the first reference position is greater than or equal to a second distance threshold and the distance between the terminal and the first reference position at a first moment is increased relative to the distance between the terminal and the first reference position at a second moment, wherein the first moment is an end point of the third period, the second moment is a start point of the third period, and the first reference position is a reference position of the first region.

12. A method of measurement control, comprising:
configuring, by a network side device, related information of a first region for a terminal, wherein the first region is within a coverage range of a network of a first network type, a first frequency is at least one of a second frequency associated with the first region, and the second frequency is a frequency used for deployment of the network of the first network type, and the first frequency is not used by the terminal for performing measurement on a neighboring cell.

13. The method according to claim 12, further comprising:
configuring, by the network side device, a measurement control policy for the terminal, wherein the measurement control policy indicates the terminal to skip performing a measurement on the neighboring cell at the first frequency when the terminal does not enter the first region or is getting away from the first region.

14. A terminal, comprising: a memory storing a computer program; and a processor coupled to the memory and configured to execute the computer program to perform operations comprising:
skipping performing measurement on a neighboring cell at a first frequency when the terminal does not enter a first region or is getting away from the first region,
wherein the first region is within a coverage range of a network of a first network type, the first frequency is at least one of a second frequency associated with the first region, and the second frequency is a frequency used for deployment of the network of the first network type.

15. The terminal according claim 14, wherein the terminal resides in a Non-Terrestrial Network (NTN) cell, and the neighboring cell comprises a Terrestrial Network (TN) cell.

16. The terminal according to claim 14, wherein the first region comprises:
a region associated with at least one third frequency, wherein the third frequency is a frequency used for deployment of the network of the first network type.

17. The terminal according to claim 16, wherein the second frequency is the at least one third frequency.

18. The terminal according to claim 14, wherein before the skipping performing measurement on a neighboring cell at a first frequency, the operations further comprise:
performing, by the terminal, a process of obtaining related information of the first region.

19. The terminal according to claim 16, wherein that the terminal does not enter the first region or is getting away from the first region comprises at least one of the following:
determining, based on a position of the terminal, that the terminal does not enter the first region or is getting away from the first region;
determining, based on signal quality of a cell associated with the first region, that the terminal does not enter the first region or is getting away from the first region; or
determining, based on a signal strength of the cell associated with the first region, that the terminal does not enter the first region or is getting away from the first region,
wherein the cell associated with the first region is the at least one first cell or a cell at the at least one third frequency.

20. A network side device, comprising: a memory storing a computer program; and a processor coupled to the memory and configured to execute the computer program to perform the method of measurement control according to claim 12.
